(19) United States
(12) Patent Application Publication
(10) Pub. No.: US 2018/0313127 A1
(43) Pub. Date: Nov. 1, 2018

(54) FLEXIBLE RACK FOR LINEAR FREE-RUN DAMPER

(71) Applicant: ILLINOIS TOOL WORKS INC., Glenview, IL (US)

(72) Inventor: Hin B. Chow, Troy, MI (US)

(21) Appl. No.: 15/771,657

(22) PCT Filed: Dec. 5, 2016
(86) PCT No.: PCT/US2016/064977

§ 371 Date: Apr. 27, 2018

Related U.S. Application Data
(60) Provisional application No. 62/265,153, filed on Dec. 9, 2015.

(51) Int. Cl. E05F 3/14

(52) U.S. Cl. CPC E05F 3/14; F16F 9/12; E05Y 2201/264; E05Y 2201/254

(57) ABSTRACT

A linear damper includes a damper housing, a rotor (20) positioned in the damper housing and a pinion (18) operably mounted to the rotor (20). A linear rack (14) has a base (32) and at least one upstanding side wall (30, 34), generally perpendicular to the base (32). The rack (14) has teeth (26) thereon for engagement with the pinion (18) as the pinion (18) moves along the rack (14) in a direction. The rack (14) has a plurality of elongated slots (40) formed therein in the direction of movement of the pinion (18) along the rack (14).

### CROSS-REFERENCE TO RELATED APPLICATION DATA

This application claims the benefit of and priority to Provisional U.S. Patent Application Ser. No. 62/265,153, filed Dec. 9, 2015, the disclosure of which is incorporated herein in its entirety.

### BACKGROUND

Dampening devices are used to dampen the movement of an object, such as a pivotally supported structural part. One example of such a pivotally supported part is the closure of a door of a glove compartment in an automobile. To dampen the movement of the door, rotary dampers and rack gears or racks are often used. Conventional rotary dampers include a rotor which is rotatably mounted in a housing. A braking fluid such as a silicone oil between the rotor and the housing provides for a dampening action when the rotor is being rotated in the housing. A pinion is mounted on the rotor shaft and engages the teeth of the rack. As the damper moves along the rack, the pinion engages the rack gear teeth and rotates the rotor within the fluid, thus dampening movement of the pinion. Imprecise engagement between the rack and the pinion may generate unacceptable noises; for example, unless the rotary damper is constrained, it may rattle when subject to vibration. At substantial loads the pinion may slide along the rack.

One configuration of rack includes a U-shaped cross-section having upstanding sides and a floor. The rack teeth are located on one of the upstanding sides. The base or floor of the rack, that is the central portion between the upstanding legs, is solid and as such, the rack is relatively stiff and inflexible. This ensures engagement between the pinion and the rack.

One drawback with maintaining such a stiff or inflexible rack is that the nip of the rotor can rub on the floor of the rack. In some cases, the frictional forces due to rubbing are so high that the rotor will bind on the floor of the rack. It has been found that during operation, the rotor nip rubs and in some cases binds on the floor of the rack along a portion of the rack referred to as the central runway.

In this rack design, the resistance from the linear free run damper is generated, in part, from the torque of the damper assembly in the dampening direction, with the remaining resistance coming from the friction among all of moveable components in both the dampening and free run directions. To avoid potential noise and rattle in the damper, a small axial interference (in the direction parallel to the axis of rotation of the rotor) is designed into the system to avoid any significant clearance. This is currently accomplished by controlling the dimensions of multiple components in the assembly.

In that known racks used in this damper are solid and inflexible, any dimensional variation can result in excessive normal load, also referred to as binding. The resulting friction is high and fluctuates depending on the dimensional stack-up of the components, as well as settling of overall height of damper assembly over time. When the frictional force is too high, the damper assembly, at the base where it contacts the rack (along the central runway), requires manual adjustment of the damper assembly at the nip to reduce the overall height. This in turn causes even more dimensional and force variations.

Accordingly there is a need for an improved damper assembly that reduces or eliminates the frictional forces due to rubbing of the damper assembly along the rack. Desirably, such a damper assembly provides the desired damping effect without undue “noise”. More desirably still, in such a damper assembly, the tolerances are maintained and the friction is reduced without the need to manually adjust any parts of the assembly.

### BRIEF SUMMARY

A linear damper includes a damper housing, a rotor positioned in the damper housing and a pinion operably mounted to the rotor. A linear rack has a base and at least one upstanding side wall, generally perpendicular to the base. The rack has teeth thereon for engagement with the pinion as the pinion moves along the rack in one direction. The rack has a plurality of elongated slots therein. The slots are elongated in the direction of movement of the pinion along the rack.

In an embodiment, the rack includes a pair of upstanding sidewalls on either side of the base. The teeth are formed in one of the upstanding side walls. A longitudinal axis is defined in the floor. The elongated slots are formed on either side of and spaced from the longitudinal axis.

The slots on either side of the longitudinal axis can be staggered from one another. In an embodiment at least some of the slots have a length different from others of the elongated slots. In an embodiment, substantially all of the slots have the same length.

Spaces between adjacent slots define bridges. In an embodiment, when the damper housing is at an end position on the linear rack, the damper housing is positioned adjacent to a bridge.

The slots can take different lengths and placement configurations. In one such configuration, at least one short slot is positioned at an end of the rack.

These and other features and advantages of the present invention will be apparent from the following detailed description, in conjunction with the appended claims.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIG. 1 is an illustration of one use of a damper assembly as used in damping the movement of a panel, such as a glove compartment door, for an automobile;

FIG. 2 is a plan view of an embodiment of a flexible rack for a free run linear damper;

FIG. 3 is another plan view of the embodiment of the flexible rack;

FIG. 4 is a plan view of an embodiment of the flexible rack;

FIG. 5 is a sectional illustration of the damper assembly positioned on a flexible rack;

FIG. 6 is a graphical representation of the differences in force variation of a flexible rack compared to a solid rack of similar dimensions and damper assemblies of similar height variation;

FIG. 7 is a graphical representation of the high force of a solid rack compared to a flexible rack of similar dimensions and damper assemblies of similar height;

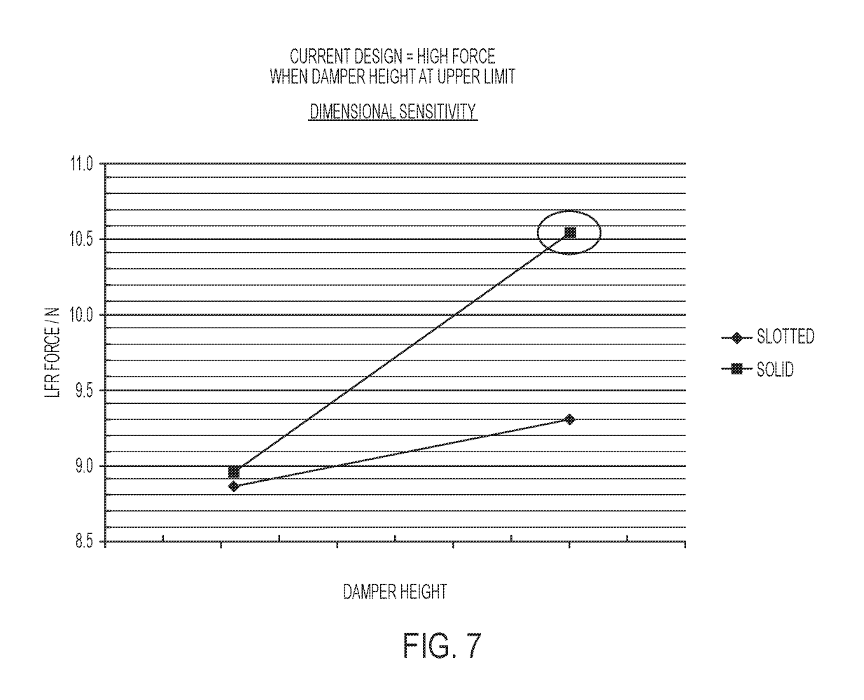

FIG. 8 is a graphical representation of the differences in force of a flexible rack compared to a solid rack of similar dimensions and damper assemblies in which the damper assembly in the solid rack is manually adjusted to reduce the required force;

FIG. 9 is a representation of the differences in force of a flexible rack compared to a solid rack of similar dimensions and damper assemblies in which the damper assembly in the solid rack is not manually adjusted to reduce the required force;

FIG. 10 is a representation of a finite element analysis illustrating the maximum deflection along the flexible rack at a location at which the damper assembly is located;

FIG. 11 is another view of the load deflection along the flexible rack;

FIG. 12 is a graphical representation of the maximum load deflection plot under similar loads of a solid rack and the flexible rack; and

FIG. 13 is a graphical representation of a stiffness plot of a solid rack and the flexible rack.

### DETAILED DESCRIPTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

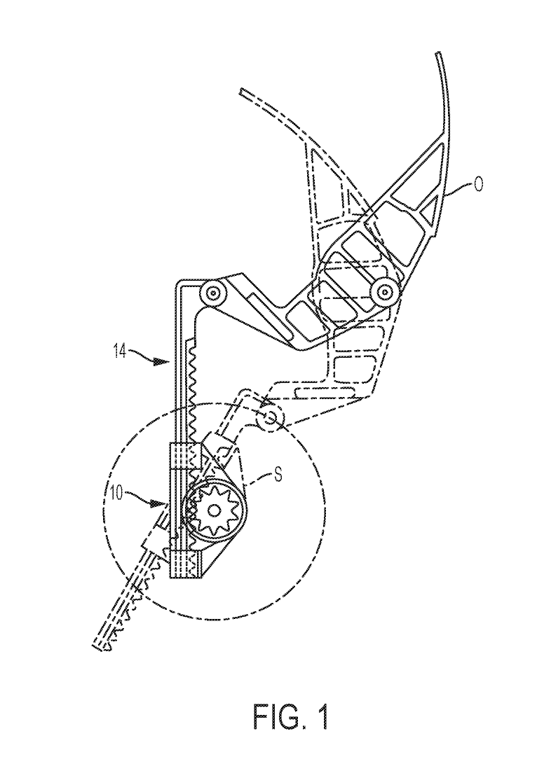

Referring to the figures and in particular to FIG. 1, there is shown one typical use for a damper assembly 10 that is used to dampen the movement of a panel O, such as a glove compartment door, for an automobile. The damper assembly 10 includes a damper, illustrated generally at 12, and a rack 14. The damper 12 includes a carriage 16, and a pinion 18 mounted to a rotor 20. The rotor 20 is in a fluid, such as a silicone fluid to dampen movement of the rotor 20. Those skilled in the art will recognize the configuration of such a damper 12. A lower portion as indicated at 22 of the damper 12 is defined by a depending portion of the rotor 20 that forms a pointed or conical nip 24.

The damper 12 configured to reside, at least in part in, and to cooperate with the rack 14. The rack 14 includes a plurality of teeth 26 that engage the pinion 18. In one configuration, the rack 14 has a generally U-shaped cross-section and the teeth 26 are formed on an inner surface of 28 one of the upstanding legs 30 of the U-shaped rack 14. The rack 14 has a base or floor 32 that forms the bottom of the U-shaped cross-section and extends between the upstanding legs 30, 34. The damper 12 is positioned on the rack 14 with the pinion 18 in the space between the legs 30, 34 so that the pinion 18 engages the rack teeth 26. The nip 24 is positioned on or closely adjacent to the rack floor 32 to reduce or eliminate noise and rattle in the damper assembly 10.

The rack 14 and the damper 12 each include a mounting portion 36, 38, respectively, to mount to the object O whose movement is to be damped and to another structure S, relative to the object O. For example, as illustrated in FIG. 1, the rack 14 can be pivotally mounted to the glove compartment door O and the damper 12 can be mounted to a portion of the car that is stationary S relative to the pivoting door O. In this manner, as the door O is pivoted, the pinion 18 and rack 14 move relative to one another to dampen or slow movement of the door O.

As noted above, a variety of factors can affect the ease of movement of the pinion 18 relative to the rack 14, or conversely the resistance to movement of the pinion 18 along the rack 14. One such factor is the stiffness of the rack 14.

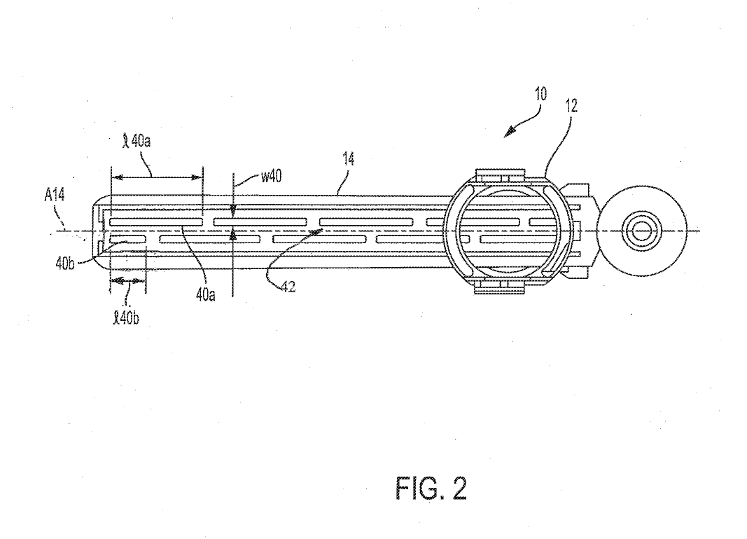

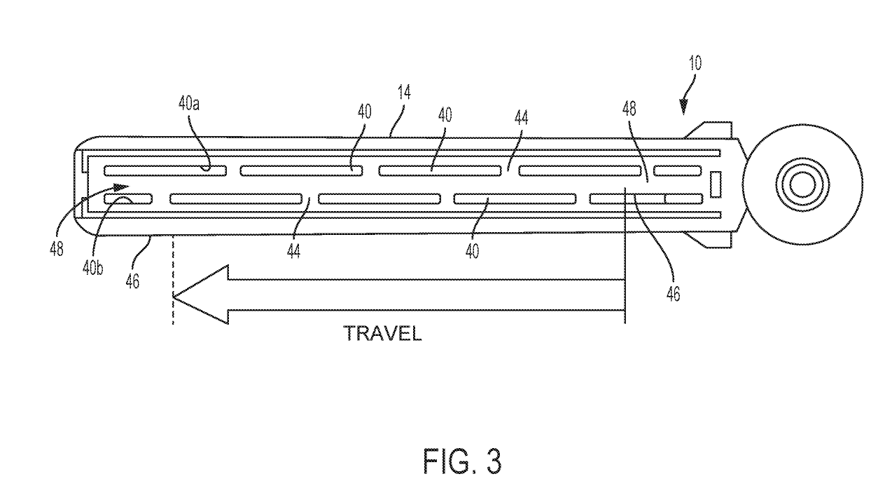

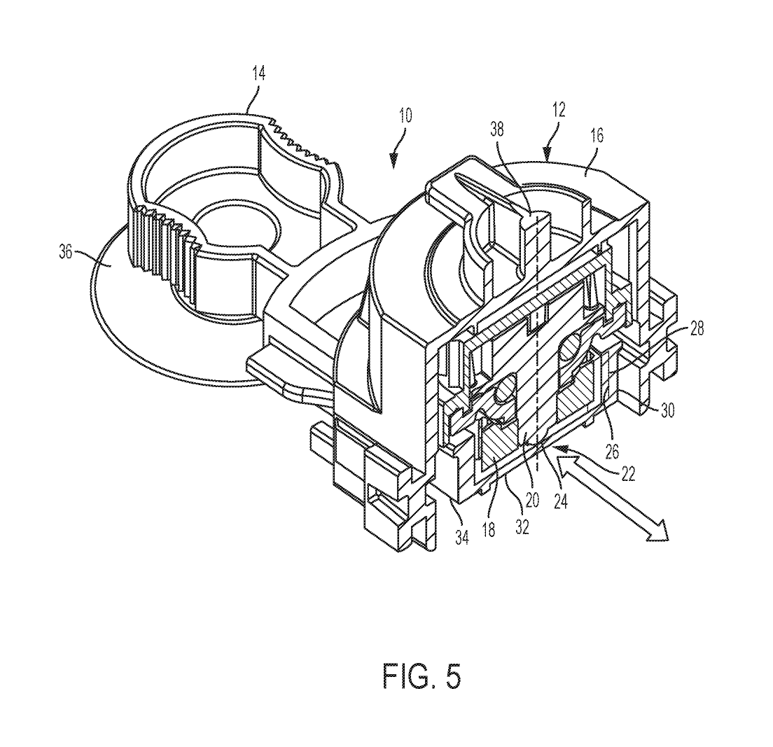

Referring now to FIGS. 2-3, there is illustrated an embodiment of a linear free run damper 12 with a flexible rack 14. The rack 14 has a floor 32 and a pair of upstanding legs or side walls 30, 34 (e.g., FIG. 5). The floor 32 includes a plurality of elongated slots 40 on opposing sides of a longitudinal axis A₁₄ of the rack 14, which longitudinal axis A₁₄ defines a central runway 42. In an embodiment, a plurality of slots 40 are formed on each side of the axis A₁₄. The slots 40 are separated from each other, in the longitudinal direction, by bridges 44 that form the floor 32 of the rack 14. The slots 40 are spaced from each other, in the transverse direction, across the central runway 42.

In one illustrative example, the slots 40 have a width w₄₀ (as measured in the transverse direction across the rack 14) of about 2.5 mm and are present in two lengths l₄₀ₐ and l_{40b} (as measured in the longitudinal direction along the rack 14) of various lengths, e.g., about 25 mm and 10 mm. The slots 40 on opposites sides of the runway 42 can be offset from each other such that the bridges 44 between slots 40 on one side of the runway are opposing a slot 40 on the other side of the runway 42 (see, FIG. 2). In such a configuration, the full extent of a long slot 40a on one side of the runway 42 is not coincident with the full extent of a slot 40 on the opposing side of the runway 42. In addition, the slots 40 on the side of the runway nearer to the upstanding wall 30 having the rack teeth 26, can be configured differently or the same as those on the opposite side of the runway 42. Such an arrangement of slots 40 reduces the fluctuation of structural flexibility along the length of the rack 14.

Referring briefly to FIG. 3, the rack 14 can also be configured such that when the object O whose movement is being dampened is in a full position in either direction (for example, when the glove compartment door is fully open or in the closed position), the nip 24 is positioned on the rack 14 between a slot 40 on one side and a bridge 44 on the opposite side (as indicated generally at 46). This provides more stability (less flexing or more stiffness) than when the nip 24 is positioned between two slots 40, and as such will result in a lesser potential for noise and rattle in the damper assembly 10. Alternatively, the rack 14 can be configured so that in the fully open or fully closed position, the nip 24 lies adjacent to a shorter slot 40b rather than a longer slot 40a (as illustrated at 48 in FIG. 3), which compensates for extra rigidity close to where the long slot ends.

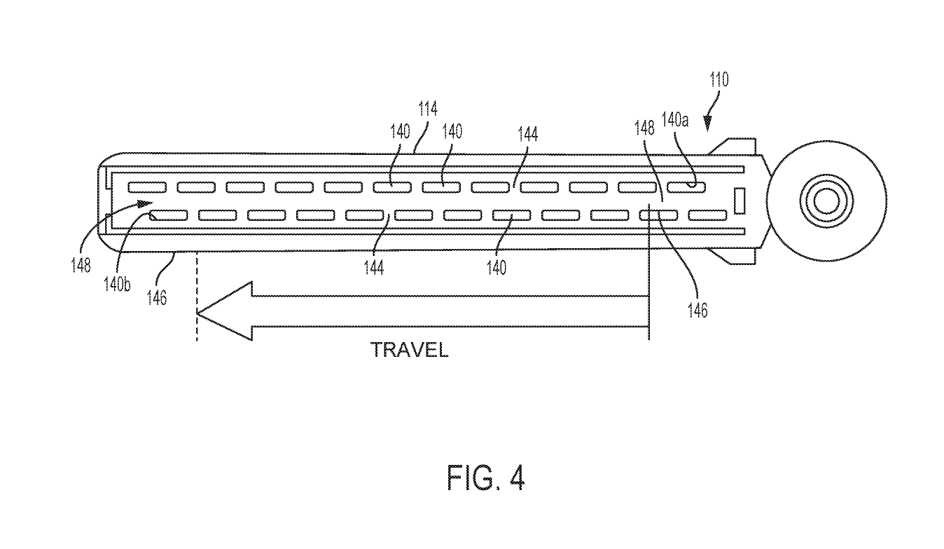

Referring to FIG. 4, there is shown an embodiment of a flexible rack 114 in which the slots 140 are about of equal length L₁₄₀. The spacing between the slots 140 (i.e., bridges 144) are also of about the same length L₁₄₄. The slots 140a,b at the ends of the rack 114 may be of a slightly different length L₁₄₀₀ than the intermediate slots 140 and can be the same or different lengths from one another. Such a configuration can compensate for extra stiffness while maintaining a reduced frictional force and noise compared to known racks.

Other configurations of slots 40, including slot lengths, spacing (bridge 44 lengths), relative positions (staggering across the runway), and on the same or opposite side as the toothed wall 30, are contemplated and are within the scope and spirit of the present disclosure. For example, it is anticipated that the rack 14 can be configured with long slots only, with long and short slots on the toothed wall 30 side, with long and short slots on the non-toothed wall 34 and with long and short slots on both walls 30, 34. Indeed, these slots can be through slots or blind slots (non-through slots) to, for example, reduce dust intrusion.

Various measurements were taken comparing the force required to move a damper 12 along an embodiment of a flexible rack 14 to that required to move a damper 12 along a stiffer, non-slotted rack. Some of the measurements further included measurements in which the damper nip 24 was adjusted (as is done with known dampers) to reduce the force needed to move the damper 12.

As an example, Table 1 below is a comparison of the force needed to move the damper in a flexible or slotted rack 14 compared to a stiff or non-slotted rack and further shows the results with the nip 24 unadjusted and manually adjusted.

TABLE 1
Comparison of the Force to Move Damper - Slotted vs. Non-Slotted Rack

| | Overall | Force | Force |
|---|---|---|---|
| | damper height | (in N) - slotted | (in N) - solid |
| Nip type | (mm) | rack | rack |
| Manually adjusted | 16.71 | 8.85 | 8.94 |
| Unadjusted | 17.00 | 9.30 | 10.54 |
| Stiffness | | 1.552 | 5.517 |

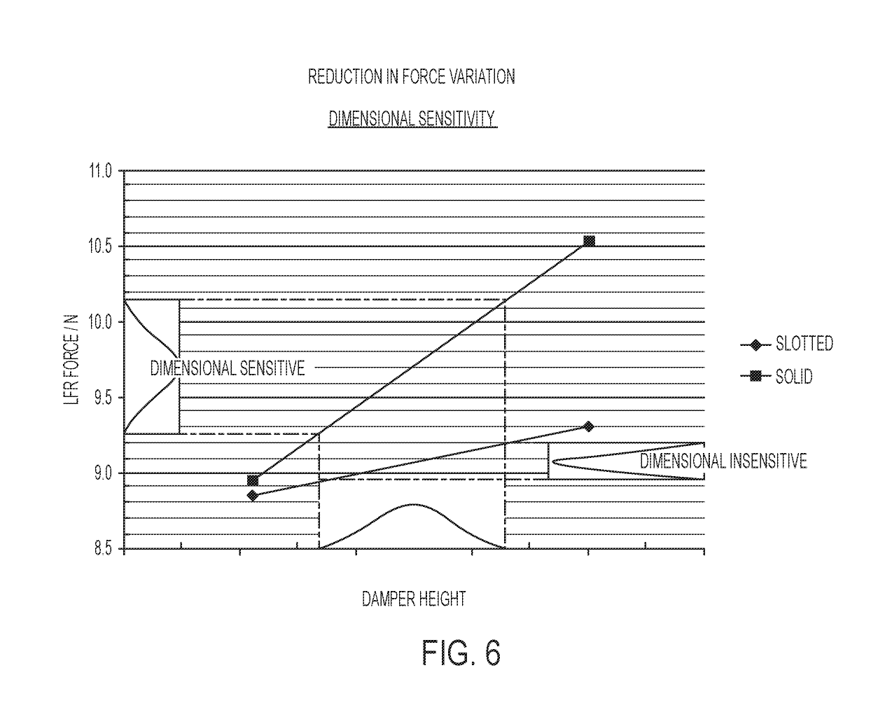

FIG. 6 shows the dimensional sensitivity of the height of the damper (the protrusion of the nip 24) for a flexible or slotted rack 14 compared to a stiff or non-slotted rack. As can be seen, not only is the overall force required considerably less for the flexible or slotted rack 14 than that of the solid rack, but the sensitivity of the force required is much less for the slotted rack. That is, as the height of the damper increases, there is less additional force required (a lower slope of the curve) than with the traditional, non-slotted rack.

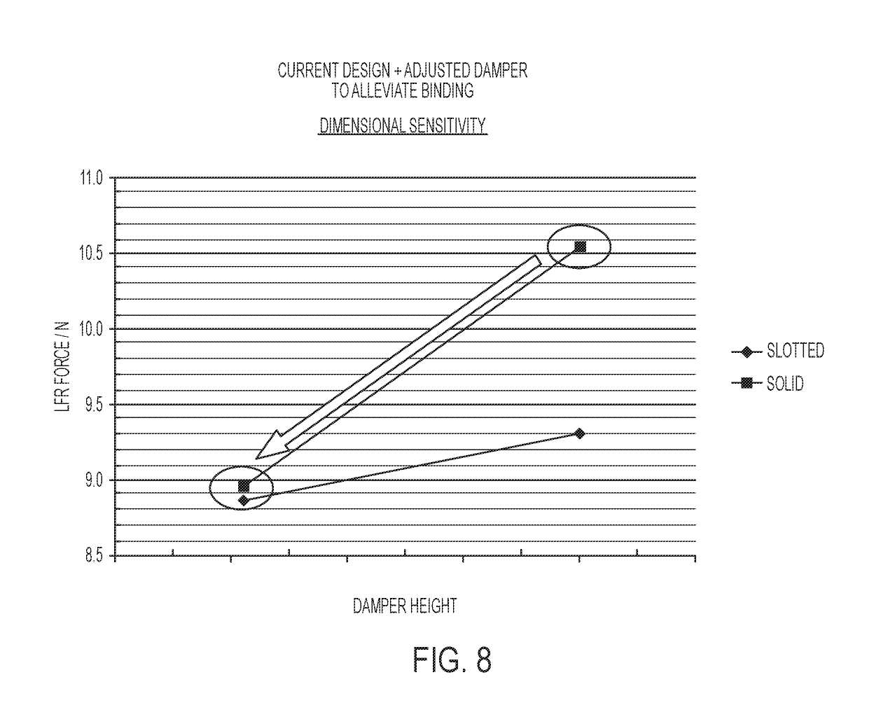

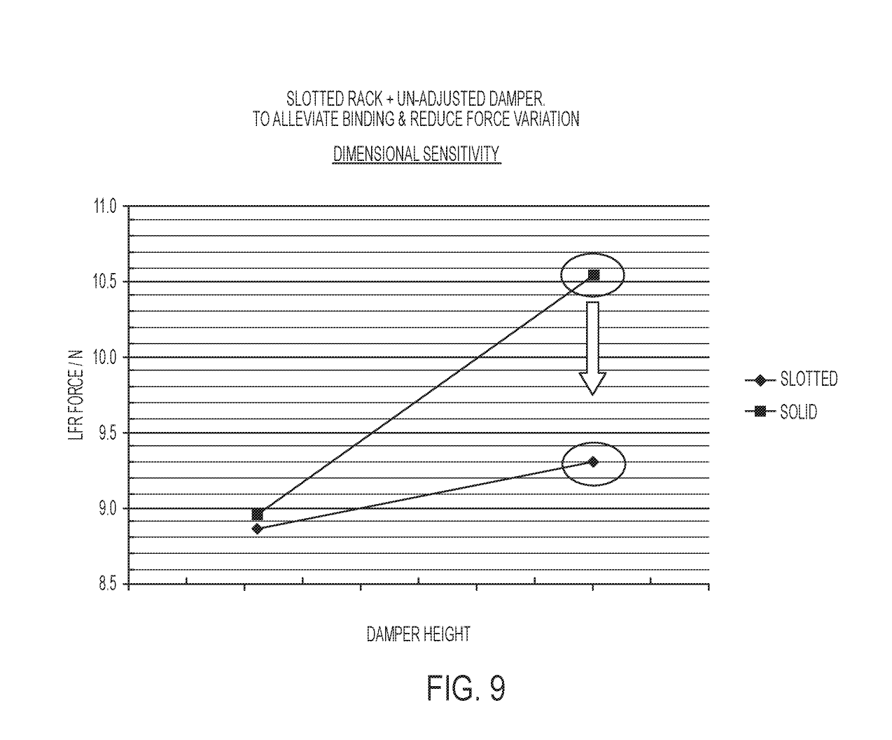

As can be seen in FIG. 8, one way in which to achieve an equivalent force reduction in the solid rack compared to the flexible rack 14 is to manually adjust the nip 24 to reduce the overall height of the damper 12 by a substantial amount. Conversely, referring to FIG. 9, a more advantageous way in which to achieve a reduction in force using a full height (unadjusted) damper is to use a slotted rack 14.

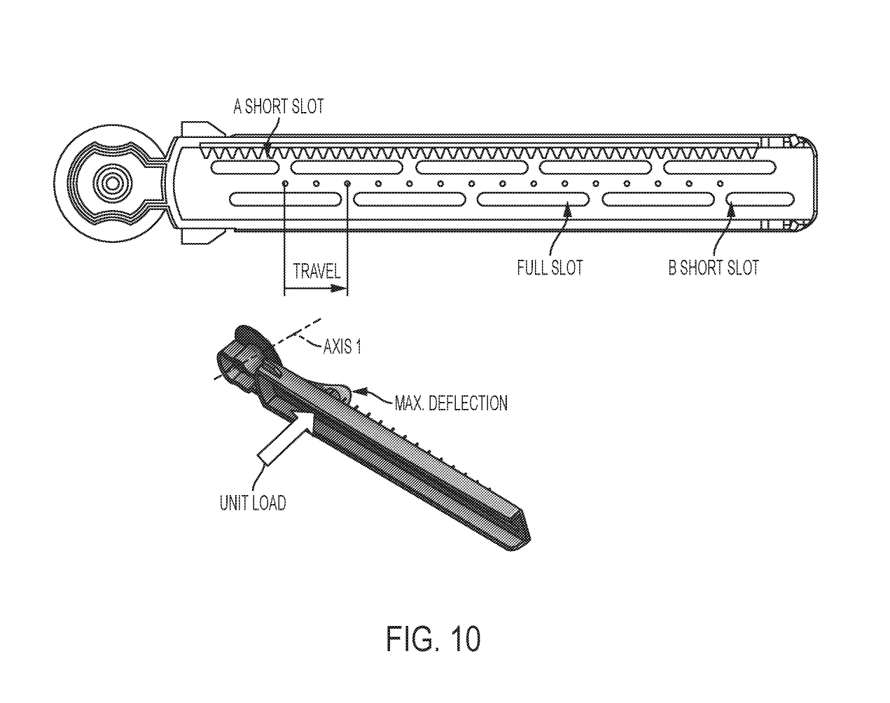

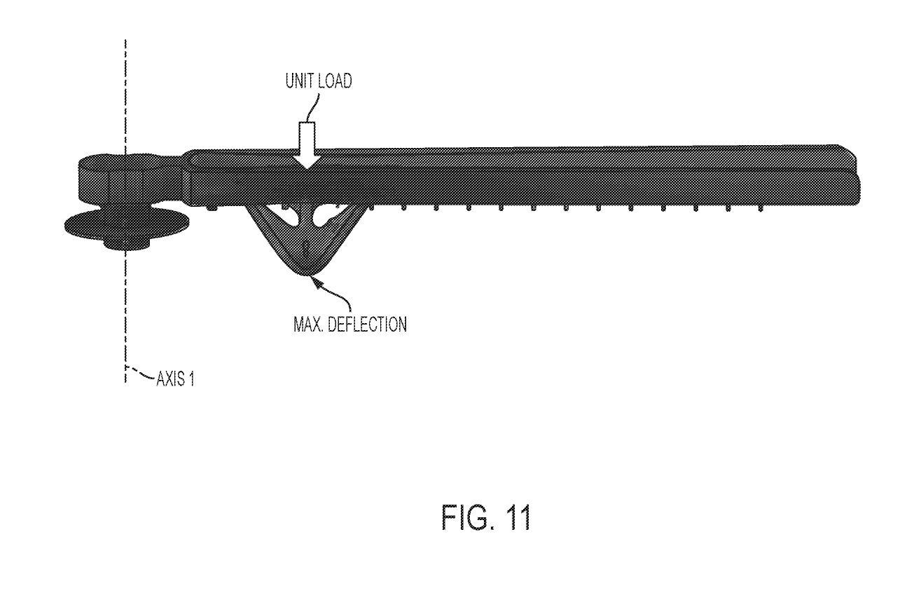

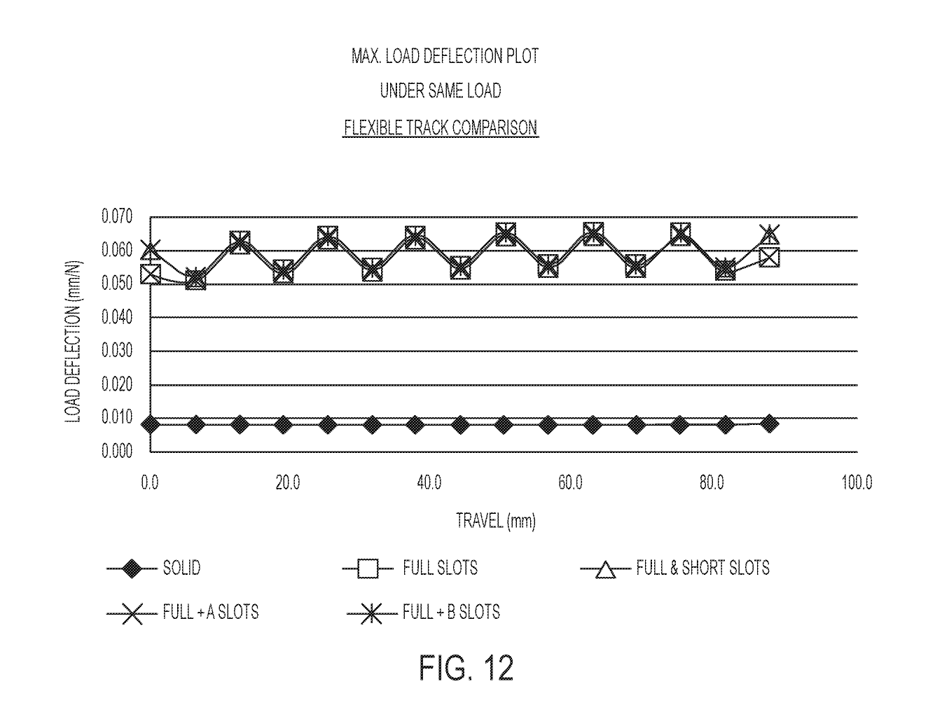

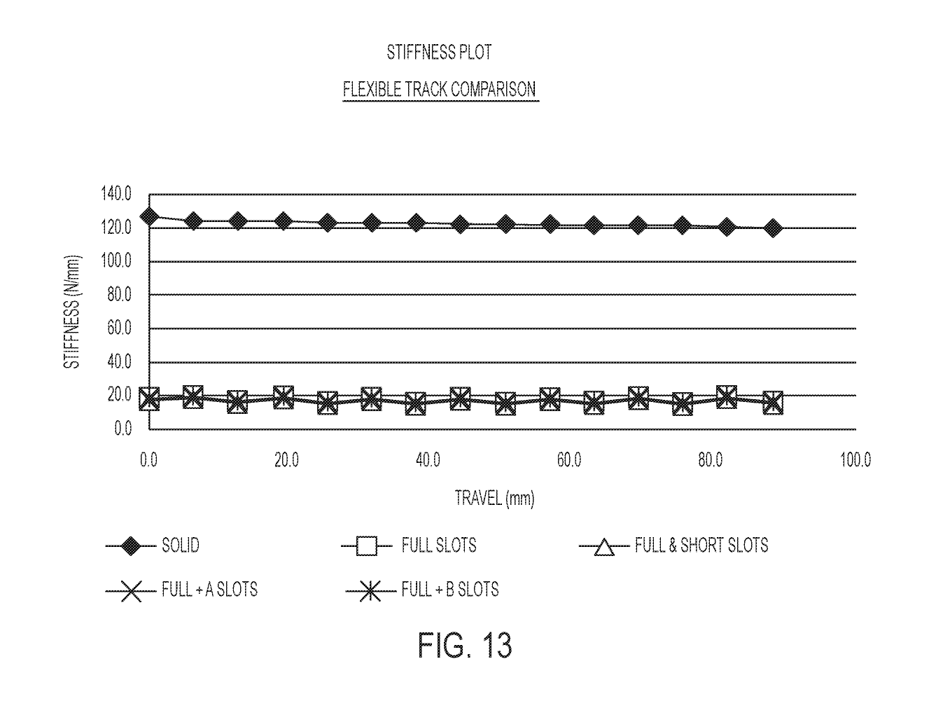

FIGS. 10 and 11 illustrate a finite element analysis showing the maximum deflection or load deflection using the slotted rack 14 made of certain materials. FIGS. 12 and 13 illustrate the load deflection and stiffness (in mm/N) for a solid rack compared to various slotted racks 14 having long (full) and short slots 40a, 40b, and slots 40 on either side of the runway 42 (A and B slots), with FIG. 12 illustrating the load deflection (greater in the slotted rack 14) and FIG. 13 illustrating the stiffness (lower in the slotted rack 14). The arrangement of slots is meant to reduce stiffness variation along the runway.

Although specific dimensions, materials, directions and the like are disclosed, those skilled in the art will recognize and appreciate that dimensions, materials, directions and the like other than those disclosed are within the scope and spirit of the present disclosure and appended claims.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

It will be appreciated by those skilled in the art that the relative directional terms such as upper, lower, rearward, forward, top, bottom and the like are for explanatory purposes only and are not intended to limit the scope of the disclosure.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

1. A linear damper comprising:
a damper housing;
a rotor positioned in the damper housing;
a pinion operably mounted to the rotor;
a linear rack, the linear rack having a base and at least one upstanding side wall, generally perpendicular to the base, the rack having teeth thereon for engagement with the pinion as the pinion moves along the rack in a direction, the rack having a plurality of elongated slots therein, the slots being elongated in the direction of movement of the pinion along the rack.

2. The linear damper of claim 1 wherein the rack includes a pair of upstanding sidewalls on either side of the base, and wherein the teeth are formed in one of the upstanding side walls.

3. The linear damper of claim 2 wherein a longitudinal axis is defined in the floor and wherein elongated slots are formed on either side of and spaced from the longitudinal axis.

4. The linear damper of claim 3 wherein the elongated slots on either side of the longitudinal axis are staggered from one another.

5. The linear damper of claim 1 wherein substantially all of the elongated slots have a same length.

6. The linear damper of claim 1 wherein at least some of the slots have a length different from others of the elongated slots.

7. The linear damper of claim 1 wherein a space between elongated slots defines a bridge.

8. The linear damper of claim 7 wherein when the damper housing is at an end position on the linear rack, the damper housing is positioned adjacent to a bridge.

9. The linear damper of claim 6 including at least one short slot on an end of the rack.
